(19) United States
(12) Patent Application Publication
(10) Pub. No.: US 2004/0162656 A1
(43) Pub. Date: Aug. 19, 2004

(54) Method for operation of a steering device for a vehicle

(76) Inventors: Wilfried Huber, Ostelsheim (DE); Alfred Lotter, Grafenau (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/737,025

(22) Filed: Dec. 16, 2003

(30) Foreign Application Priority Data
Dec. 16, 2002 (DE) DE 102 58 616.0
Jan. 22, 2003 (DE) DE 103 02 169.8

(51) Int. Cl. G06F 7/00

(52) U.S. Cl. 701/41

(57) ABSTRACT

The invention relates to a method for operation of a steering device (10) and to a steering device (10) for a vehicle, having a steering actuator (12) for setting the steering angle on the steered vehicle wheels (11) and having a steering handle (14) which is mechanically decoupled from the steering actuator (12) during disturbance-free operation. A nominal steering angle is determined on the basis of the operation of the steering handle (14) and is set on the steered vehicle wheels (11). At least during disturbance-free operation, at least one variable which describes the transverse dynamics of the vehicle is taken into account in the determination of the nominal steering angle. A disturbance influence which acts laterally with respect to the direction of travel is also determined from this variable which describes the transverse dynamics of the vehicle or from an assessment variable which is derived from it.

### CROSS-REFERENCE TO RELATED APPLICATIONS

This application claims the benefit of the filing dates of German Application Serial No. DE 102 58 616.0 filed on Dec. 16, 2002 and German Application Serial No. De 103 02 169.8 filed on Jan. 22, 2003.

### BACKGROUND AND SUMMARY OF THE INVENTION

The invention relates to a method for operation of a steering device for a vehicle and to a steering device.

It is known from German reference DE 195 46 733 C1 which forms the generic prior art for steering devices to be provided in vehicles, in which the steering has a steering actuator for setting the steering angle of the steerable wheels. The steering actuator is in this case mechanically decoupled from the driver-operated steering handle during normal operation. A nominal steering angle can be determined in a computation device on the basis of the operation of the steering handle by the driver. This nominal steering angle is then set automatically by appropriate operation of the steering actuator during disturbance-free normal operation.

It is also known from German reference DE 42 29 380 A1 for additional steering to be used to compensate independently of the driver for a side wind which is acting on the vehicle and is causing the vehicle to diverge from the path which is intrinsically set by the steering handle. Without appropriate compensation, that is to say without a correction to the steering, the vehicle would leave the lane. One consequence of this procedure is that the driver is no longer aware of the transverse forces which are acting on the vehicle and which he must counteract by operation of the steering handle.

Driving states in which a safe driving situation admittedly exists on the basis of active compensation for side wind disturbances that is independent of the driver but in which the driver can no longer carry out the steering task directly without automatic steering assistance may be problematic. This is problematic because the driver must in some circumstances suddenly and unexpectedly take over the entire steering task again, for example in the event of a fault in the steering device, and should then not be confronted with steering tasks that cannot be coped with. Since the driver perceives the external disturbance influences, in particular long-lasting disturbances, on the vehicle only to a minor extent owing to the automatic compensation and does not regard them as being critical, it is, however, impossible for him to avoid these driving situations—for example high vehicle longitudinal speeds with a strong side wind at the same time—in which he could no longer himself carry out the steering task.

The object of the invention is thus to ensure reliable fail-safe operation of such steering.

According to the invention, at least during disturbance-free operation, at least one variable which describes the transverse dynamics of the vehicle is taken into account in the determination of the nominal steering angle, and a disturbance influence which acts laterally with respect to the direction of travel is determined from this variable which describes the transverse dynamics of the vehicle.

The determination of the disturbance influence makes it possible to check whether the disturbance influences are in a range which also allows manual compensation by the driver if he has to take over the steering task, for example owing to a fault in the steering device. If a driving situation exists which would not be possible for the driver to cope with himself, measures can be initiated in order to change the driving situation and/or to inform the driver.

According to one preferred refinement of the invention, the disturbance influence is determined from the Fourier transformation (for example discrete on-line Fourier transformation with a fixed time window) of the at least one variable which describes the transverse dynamics of the vehicle. In this case, any other suitable transformation from the time domain to the frequency domain may be used instead of the Fourier transformation. Transformations such as these are mathematical methods which can be carried out numerically and which allow an oscillation behavior to be deduced from the time-dependent variable. The use of a method such as this makes it possible to take account of only dynamic disturbance influences in a simple manner.

According to one advantageous refinement of the invention, provision is in this case made for the oscillation amplitude and/or the oscillation frequency of the at least one variable which describes the transverse dynamics of the vehicle to be determined on the basis of the Fourier transformation. The oscillation frequency in this case represents the stimulus rate, and the oscillation amplitude describes the intensity of the disturbance influence.

The oscillation frequency is a measure of how quickly the driver would need to operate the steering handle in order to compensate for the disturbance influence, and the oscillation amplitude is a measure of how great and strong the operation or deflection of the steering handle from the rest position would need to be in this case. Thus, not only can the necessary compensating operating speed but also the deflection of the required operation of the steering handle by the driver can thus be detected.

A special operating mode is used when the at least one variable which describes the transverse dynamics of the vehicle is not taken into account in the determination of the nominal steering angle. This is the situation, for example, when a mechanical or hydraulic connection is set up between the steering handle and the steered vehicle wheels, for example because a fault has occurred in the open-loop or closed-loop control of the steering device. During disturbance-free normal operation, it is possible to use the determined disturbance influence to assess whether it will be possible for the driver to cope with the transverse dynamic control of the vehicle in the instantaneous driving situation, even in this special operating mode. This assessment is expediently carried out by evaluation of the oscillation frequency and/or of the oscillation amplitude of the at least one variable which describes the transverse dynamics of the vehicle. This means that it is always possible to assess whether the driver will be able to cope with the steering task required in the instantaneous driving situation even without automatic steering assistance by the steering device.

The fact that the driving situation can be coped with independently of the driver is deduced if the oscillation frequency is below a frequency threshold value and/or the oscillation amplitude is below an amplitude threshold value. These threshold values make it possible to define regions in which the disturbance influence would result in the steering task placing an excessive load on the driver owing to its speed and/or severity. Driving situations such as these can also be identified easily. In this case, the frequency threshold value and/or the amplitude threshold value may be dependent on the vehicle longitudinal speed and/or the variable which corresponds to the operation of the steering handle. Furthermore, the frequency threshold value and/or the amplitude threshold value may be dependent on one another. The higher the vehicle longitudinal speed, the lower are the frequencies and/or the lower are the amplitudes which are sufficient to cause a driving situation which the driver can no longer cope with manually.

An assessment as to whether driving situations can or cannot be coped with in terms of the requirement for compensation by the driver can in this case be made in particular by carrying out a group investigation with a range of normal drivers on driving simulators.

In this case, when a situation such as this which cannot be coped with exists, a change is advantageously made to a driving situation which can be coped with. The change to a driving situation which can be coped with may in this case be carried out by production of optical and/or acoustic and/or tactile driver information signals, with these driver information signals being used in particular to bring about a reduction in the vehicle longitudinal speed by the driver.

Alternatively or additionally, it is possible to carry out the change to a driving situation which can be coped with by means of an automatic influence on the vehicle longitudinal dynamics, in particular by operation of the propulsion device and/or of the braking device of the vehicle in order to reduce the vehicle longitudinal speed. The automatic reduction is preferably also carried out when the driver generates a driving command which is contrary to the reduction in the vehicle longitudinal speed. This process of automatically bringing about a safe driving situation on the one hand avoids the driver having to take suitable active measures to bring about the driving situation. On the other hand, measures such as these can also be carried out when the driver does not himself bring about the safe driving situation, for example when a predetermined time period has elapsed from the time which the optical and/or acoustic and/or tactile driver information was produced.

The decision as to whether a driving situation which can be coped with by the driver exists is preferably made as a function of at least one of the variables comprising the vehicle speed and operation of the steering handle. This allows driving situations which can be coped with to be determined as a function of the instantaneous driving situation of the vehicle and the capability to cope with this driving situation. Problems occur, for example, in the case of disturbances caused by a side wind when the vehicle longitudinal speed is high, even when the road profile is essentially straight.

It is advantageous for the variable which describes the transverse dynamics of the vehicle to be determined by means of the yaw rate and/or the transverse acceleration and/or the steering angle and/or the nominal steering angle and/or internal controlled variables such as the state variable of an observer. All of this information can be used to determine the nominal steering angle. All of this information is also suitable for representing the disturbance influence that is active. These variables are not only variables which are measured by sensors in the vehicle or variables derived from them, but also values which are determined in a computation unit in the steering device itself.

### BRIEF DESCRIPTION OF THE DRAWING

The invention will be explained in more detail in the following text with reference to the exemplary embodiment which is illustrated in the drawing, in which:

FIG. 1 shows a schematic illustration of a steering device and the associated computation unit in the form of schematic functional blocks, and

FIG. 2 shows the relationship between the amplitude threshold value, the frequency threshold value and the vehicle longitudinal speed of the Fourier transforms of the variable which describes the transverse dynamics of the vehicle.

### DETAILED DESCRIPTION OF THE DRAWING

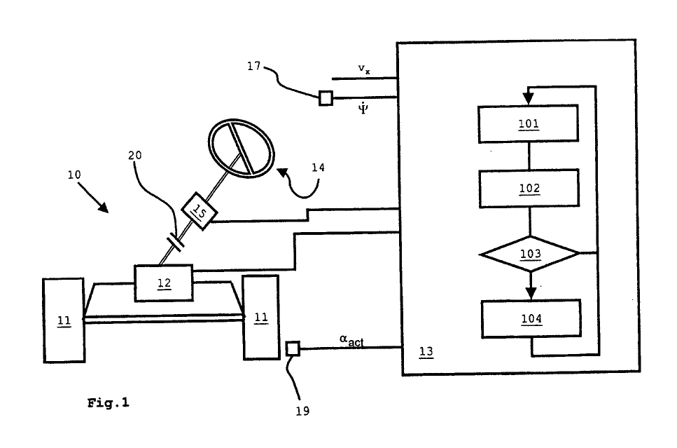

FIG. 1 shows a steering device 10 of a vehicle which is not illustrated in any more detail, with steered vehicle wheels 11. The driver of the vehicle can demand a specific steering angle on the steered vehicle wheels 11 by operation of a steering handle 14, which is formed by a steering wheel. In the disturbance-free normal operating mode, the steering device operates as follows:

By way of example, the steering wheel angle set by the driver or the torque applied by the hand to the steering handle is measured by means of a handle sensor 15 and is supplied to a computation device 13 as an input variable 16. Other input variables 16 which are transmitted to the computation device 13 include, for example, the yaw rate \dot{Ψ} of the vehicle, as determined by a yaw rate sensor 17, and the vehicle longitudinal speed vₓ. The computation device 13 uses the input variables to determine the nominal steering angle αₙₒₘ, and emits this to a steering actuator 12, which is provided for setting the steering angle on the steered vehicle wheels.

The actual steering angle α_{act} that is actually set is measured by means of a steering angle sensor 19, and is transmitted to the computation device 13 in order to control the steering angle.

As an alternative to this, instead of or in addition to the yaw rate \dot{Ψ} as a variable which describes the transverse dynamics of the vehicle in order to determine the nominal steering angle, it would also be possible to take into account the transverse acceleration ay and/or internal control variables such as a state variable of an observer.

During disturbance-free normal operation, transverse-dynamic disturbance influences which act on the vehicle are also taken into account in the determination of the nominal steering angle αₙₒₘ and are controlled out automatically, so that the driver does not regard these disturbance influences as being critical while driving.

A mechanical reversionary level is provided as a special operating mode for the steering device 10 according to FIG. 1. In order to activate the special operating mode, a clutch 20, which decouples the steering handle 14 and the steered vehicle wheels 11 from one another during normal operation, is closed, so that there is then a continuous mechanical connection between the steering handle 14 and the steered vehicle wheels 11. This special operating mode is activated, for example, in the event of a fault in the electrical control system for the steering device, in order to maintain the capability to steer the vehicle.

However, in the special operating mode, the variable which describes the transverse dynamics of the vehicle is no longer taken into account in the setting of the steering angle. The driver has to take over the entire steering task himself, in which case he must also compensate for the transverse-dynamic disturbance influences by appropriate manual steering handle operations.

A transverse-dynamic disturbance influence which is acting on the vehicle can be determined while the steering device is operating in the disturbance-free normal mode from the variable which describes the transverse dynamics of the vehicle and is taken into account in the determination of the nominal steering angle αₙₒₘ, or from an assessment variable which is derived from this. The nominal steering angle αₙₒₘ or the actual steering angle α_{act} may also be used, for example, as the assessment variable since the disturbance influence has already been taken into account in them and can thus also be extracted again.

In a first method step 101, the variable which describes the transverse dynamics of the vehicle or the assessment variable which is derived from it, for example the yaw rate \dot{Ψ}, is determined in the computation unit 13. The Fourier transform F(\dot{Ψ}) of the yaw rate \dot{Ψ} is calculated, and the oscillation frequency f and the oscillation amplitude A are determined, in a second step 102.

The oscillation amplitude A and the oscillation frequency f of the Fourier transforms F(\dot{Ψ}) are used in the third step 103 to determine whether the steering task which results from the instantaneous driving situation can or cannot be coped with by the driver even without the disturbance influence being regulated out automatically. For example, the driver can carry out steering handle operations only at a maximum operating rate, which is dependent on the magnitude of the operation or deflection of the steering handle 14 from its rest position as required in this case. Threshold values can thus be defined for the oscillation frequency and for the amplitude of the Fourier transforms F(\dot{Ψ}), which separate a first region I of driving situations which can be coped with by the driver and a second region II of driving states which cannot be coped with by the driver.

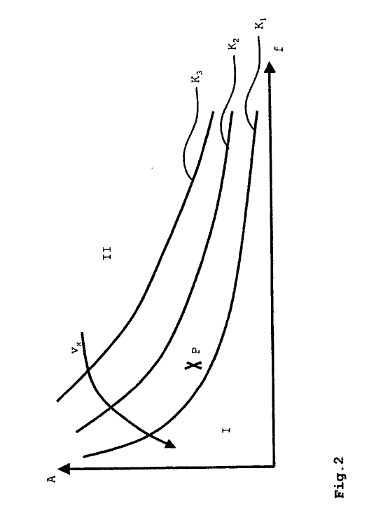

The relationship between the oscillation frequency f and the oscillation amplitude A is illustrated in FIG. 2. This also takes account of the dependency of the vehicle longitudinal speed vₓ, with each curve K₁, K₂, K₃ corresponding to a specific vehicle longitudinal speed vₓ. The curves K₁, K₂, K₃ in each case separate the two regions I, II which are associated with them. The region between the curve and the coordinate axes is in each case the first region I, which characterizes driving situations which can be coped with by the driver. The second region II in each case beyond the curve identifies driving situations which can no longer be coped with by the driver, since the steering task would overload him.

If a driving situation which can be coped with by the driver exists in the third step 103, then the process jumps back to the first step 101.

Let us assume that the oscillation frequency f and the oscillation amplitude A of the Fourier transforms F(\dot{Ψ}) mark the point P, and that the curve K₁ applies on the basis of the instantaneous vehicle longitudinal speed Vₓ. The point P is located in the second region II and thus identifies a driving situation which cannot be coped with by the driver, as is determined in the third step 103, so that a jump is made to the fourth step 104. The fourth step 104 thus results in a driving situation being brought about which can be coped with. This is done, for example, by demanding that the driver reduce the vehicle longitudinal speed vₓ, for example by means of optical and/or acoustic and/or tactile driver information. If the driver does not react, it is possible in a further step in a modified form of the illustrated exemplary embodiment to carry out an automatic longitudinal control action in order to reduce the vehicle longitudinal speed vₓ, for example by operating the propulsion device and/or the braking device of the vehicle. In this way, it is possible to make the change to a curve K2, K3 whose first region I includes the point P, so that this then once again results in a driving situation which can be coped with by the driver. The process then jumps back to the step 101.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method of operating a steering device for a vehicle, having a steering actuator for setting the steering angle of the steered vehicle wheels and having a steering handle which is mechanically decoupled from the steering actuator during disturbance-free operation, with a nominal steering angle being determined on the basis of the operation of the steering handle and being set on the steered vehicle wheels, the method comprising:
sensing at least one variable which describes the transverse dynamics of the vehicle;
determining a nominal steering angle based on said at least one variable; and
determining a disturbance influence which acts laterally with respect to the direction of travel from said at least one variable which describes the transverse dynamics of the vehicle or from an assessment variable derived from said at least one variable.

2. The method as claimed in claim 1,
wherein
the disturbance influence is determined from the Fourier transformation of the at least one variable which describes the transverse dynamics of the vehicle.

3. The method as claimed in claim 2,
wherein
the oscillation amplitude and/or the oscillation frequency of the at least one variable which describes the transverse dynamics of the vehicle are/is determined by means of the Fourier transformation.

4. The method as claimed in claim 1,
wherein
a special operating mode is used when the at least one variable which describes the transverse dynamics of the vehicle is not taken into account in the determination of the nominal steering angle.

5. The method as claimed in claim 4,
wherein
the determined disturbance influence is used to assess whether the driver can cope with the transverse dynamic control of the vehicle in the instantaneous driving situation, even in the special operating mode.

6. The method as claimed in claim 5,
wherein
the capability to cope with the driving situation is assessed by evaluation of an oscillation frequency and/or of an oscillation amplitude of the at least one variable which describes the transverse dynamics of the vehicle.

7. The method as claimed in claim 6,
wherein
it is possible to cope with the driving situation when the oscillation frequency is below a frequency threshold value and/or the oscillation amplitude is below an amplitude threshold value.

8. The method as claimed in claim 6,
wherein
the frequency threshold value and/or the amplitude threshold value are/is dependent on the vehicle longitudinal speed and/or on the variable which corresponds to the operation of the steering handle.

9. The method as claimed in claim 6,
wherein
the frequency threshold value and/or the amplitude threshold value are dependent on one another.

10. The method as claimed in claim 5,
wherein
on identification that it is not possible for the driver to cope with the driving situation, a change is initiated to a driving situation which can be coped with.

11. The method as claimed in claim 10,
wherein
the change to a driving situation which can be coped with is made by production of optical and/or acoustic and/or tactile driver information signals, with these driver information signals being used to bring about a reduction in the vehicle longitudinal speed by the driver.

12. The method as claimed in claim 10,
wherein
the change to a driving situation which can be coped with is carried out by automatically influencing the vehicle longitudinal dynamics by operation of the propulsion device and/or of the braking device of the vehicle in order to reduce the vehicle longitudinal speed.

13. The method as claimed in claim 12,
wherein
the vehicle longitudinal dynamics are also influenced when the driver generates a driving command which is contrary to this.

14. The method as claimed in claim 1,
wherein
the variable which describes the transverse dynamics of the vehicle is determined by means of the yaw rate and/or the transverse acceleration and/or the steering angle and/or the nominal steering angle and/or internal controlled variables such as the state variable of an observer.

15. A steering device for a vehicle, comprising:
a steering actuator for setting the steering angle on the steered vehicle wheels;
a steering handle which is mechanically decoupled from the steering actuator during disturbance-free operation; and
a computation device which determines a nominal steering angle on the basis of the operation of the steering handle and operates the steering actuator in order to set the steering angle,
wherein,
at least during disturbance-free operation, at least one variable which describes the transverse dynamics of the vehicle is taken into account by the computation device in the determination of the nominal steering angle, and wherein a disturbance influence which acts laterally with respect to the direction of travel is determined by the computation device from this variable which describes the transverse dynamics of the vehicle.

16. The steering device as claimed in claim 30,
wherein
a special operating mode is used when the at least one variable which describes the transverse dynamics of the vehicle is not taken into account in the determination of the nominal steering angle, with the special mode being activated in particular by setting up a mechanical and/or hydraulic connection between the steering handle (14) and the steered vehicle wheels (11).

17. A steering device for a vehicle, comprising:
a sensor to generate a first signal indicative of a transverse dynamics of said vehicle; and
a computation device to generate a second signal if said first signal indicates that said transverse dynamics is greater than a predetermined transverse threshold dynamics indicative of unsafe transverse dynamics of said vehicle.

18. The steering device of claim 17, wherein said first signal is indicative of a yaw rate of said vehicle.

19. The steering device of claim 17, wherein said first signal is indicative of a transverse acceleration of said vehicle.

20. The steering device of claim 17, wherein said first signal is indicative of a steering angle of a steering wheel of said vehicle.

21. The steering device of claim 17, wherein said first signal is indicative of a nominal steering angle of a steering wheel of said vehicle.

22. The steering device of claim 17, further comprising an optical device responsive to said second signal to alert a driver of said vehicle of unsafe transverse dynamics of said vehicle.

23. The steering device of claim 17, further comprising an audible device responsive to said second signal to alert a driver of said vehicle of unsafe transverse dynamics of said vehicle

24. The steering device of claim 17, further comprising a tactile device responsive to said second signal to alert a driver of said vehicle of unsafe transverse dynamics of said vehicle.

25. The steering device of claim 17, further comprising a propulsion device responsive to said second signal to lower a longitudinal speed of said vehicle if said second signal indicates an unsafe transverse dynamics of said vehicle.

26. The steering device of claim 17, further comprising a braking device responsive to said second signal to lower a longitudinal speed of said vehicle if said second signal indicates an unsafe transverse dynamics of said vehicle.

27. The steering device of claim 17, wherein said computation device determines an oscillation frequency and/or an oscillation amplitude related to said first signal.

28. The steering device of claim 27, wherein said computation device determines said oscillation frequency and/or said oscillation amplitude by performing a Fourier transform on said first signal.

29. A method comprising:
sensing a transverse dynamics of a vehicle; and
alerting a driver of said vehicle and/or controlling a movement of said vehicle if the sensed transverse dynamics is greater than a predetermined unsafe transverse dynamics.

30. The method of claim 29, wherein sensing a transverse dynamics of said vehicle comprises sensing a yaw rate of said vehicle.

31. The method of claim 29, wherein sensing a transverse dynamics of said vehicle comprises sensing a transverse acceleration of said vehicle.

32. The method of claim 29, wherein sensing a transverse dynamics of said vehicle comprises sensing a steering angle of a steering wheel of said vehicle.

33. The method of claim 29, wherein sensing a transverse dynamics of said vehicle comprises sensing a nominal steering angle of a steering wheel of said vehicle.

34. The method of claim 29, wherein alerting said driver of said vehicle comprises optically alerting said driver.

35. The method of claim 29, wherein alerting said driver of said vehicle comprises audibly alerting said driver.

36. The method of claim 29, wherein alerting said driver of said vehicle comprise tactily alerting said driver.

37. The method of claim 29, wherein controlling said movement of said vehicle comprises reducing a longitudinal speed of said vehicle.

38. The method of claim 37, wherein reducing said longitudinal speed of said vehicle comprises operating a propulsion device of said vehicle.

39. The method of claim 37, wherein reducing said longitudinal speed of said vehicle comprises operating a braking device of said vehicle.

40. The method of claim 29, further comprising determining an oscillation frequency and/or an oscillation amplitude related to said sensed transverse dynamics.

41. The method of claim 40, wherein determining said oscillation frequency and/or said oscillation amplitude comprises performing a Fourier transform on said sensed transverse dynamics.
